(19) United States
(12) Patent Application Publication
(10) Pub. No.: US 2026/0212842 A1
(43) Pub. Date: Jul. 23, 2026

(54) FLUTE KEY WITH IMPROVED FLUTE KEY CUP AND STABILIZING DISC

(71) Applicant: Eastman Wind Instruments, Inc., Acton, MA (US)

(72) Inventors: David Shipani, West Roxbury, MA (US); Thomas Otto, Bolton, MA (US); Joy Roberts, Lowell, MA (US)

(73) Assignee: Eastman Wind Instruments, Inc., Acton, MA (US)

(21) Appl. No.: 19/033,879

(22) Filed: Jan. 22, 2025

(51) Int. Cl. G10D 9/04; G10D 7/02

(52) U.S. Cl. CPC G10D 9/04; G10D 7/02

(57) ABSTRACT

Described is a two-component system of a computer numerical control (CNC) machined flute key cup and a CNC machined, screw-in flute pad stabilizing disc which screws into a central threaded post machined as part of the machined key cup. The screw-in stabilizing disc bottoms out and locks into place inside the key cup to provide a stable and consistent foundation for the installation of the flute pad that is affixed with a pad screw to the post.

### BACKGROUND OF THE INVENTION

### (1) Field of Invention

The present invention relates to musical instruments and associated parts, and more particularly to a flute key having an improved flute key cup and associated stabilizing disc.

### (2) Description of Related Art

Woodwind instruments, such as the flute, use a series of flute keys that are selectively raised and lowered from tone holes as the instrument is played. The flute keys are generally comprised of flute key cups and pads. As shown in FIGS. 1 and 2, prior art examples of flute key cups are either solid machined cups or stamped key cups, respectively. As shown in FIG. 1, the solid machined keys include the solid machined cup 100 and associated flute pad 102. A pad screw 104 and washer 106 hold the flute pad 102 in place, with the pad screw 104 being screwed directly into the machined cup 100. A glued-in floating stabilizer disk 108 is glued onto a flattened surface 101 within the machine cup 100 and separated from the flute pad 102 by a shim 110. While generally operable, the solid machined cups 100 suffer from several issues, including being relatively heavy, being less customizable due to the glued-in stabilizing disks 108 and not being able to accommodate varying thicknesses of pads 102 without increasing the number of shims 110. Additionally, the solid machined cup 100 is exposed to various soldering and forming operations during the manufacture of the flute mechanism. These operations expose the solid machined key cup 100 to stresses relating to heat and forming which affect the tone and quality of the instrument. Other issues arise due to the glue. Gluing the stabilizing disc 108 into the pad cup 100 results in varying overall interior cup depths because the volume of glue used is never exactly equal from cup to cup. This will result in the glued-in floating stabilizer disk 108 riding higher in a cup with more glue or riding lower with a cup with less glue, changing the play and tone characteristics from cup to cup. Additionally, the distribution of glue around the entire disc is not perfectly uniform, resulting in the stabilizing disc 108 sitting slightly off level inside the cup 100. The off-level disc 108 can have the effect of not sealing properly against the tone hole or otherwise affecting the sound emanating from the instrument.

Similarly and as shown in FIG. 2, the stamped key cup 200 also includes an associated flute pad 202. A pad screw 204 and washer 206 hold the flute pad 202 in place, with the pad screw 204 being screwed directly into a brass spud 205. The brass spud 205 is a small, threaded piece of metal soldered into the cup 200. A glued-in floating stabilizer disk 208 is also glued within the stamped key cup 200 and separated from the flute pad 202 by a shim 210. As can be appreciated by those skilled in the art, the stamped key cup 200 suffers from many of the same issues as referenced above regarding the solid machined cup 100. Further, thin stamped cups are prone to distortion when exposed to the heat and pressure stresses involved in the manufacture of the flute mechanism, affecting their tonal quality and strength.

Thus, a continuing need exists for a flute key with an improved key cup and associated parts that address the deficiencies of the prior art.

### SUMMARY OF INVENTION

The present disclosure provides an improved flute key and method for making and using the same. The flute key includes a machined flute key cup having an integral, centered, externally threaded post. A machined flute stabilizing disc having an internally threaded hole is selectively threadable around the post. A flute pad is positioned within the key cup. A washer is attached with the flute pad, while a pad screw passes through the washer, flute pad, and stabilizing disc and is affixed to the post.

In another aspect, each of the machined flute key cup and machined flute stabilizing disc are computer numerical control (CNC) machined.

In yet another aspect, the post includes an internally threaded bore, with the pad screw affixed to the internally threaded bore.

In another aspect, a shim is positioned between the stabilizing disc and flute pad.

In yet another aspect, the key cup is machined to have a hollow cup space that circumferentially surrounds the post. The hollow cup space is stepped to include a step face that surrounds the post.

In another aspect, the stabilizing disc is machined to have a hollow disc space that circumferentially surrounds the post.

In another aspect, the present disclosure is directed to a flute itself, having the improved flute key. In this aspect, the flute includes a flute body having a plurality of tone holes, each with a flute key hingedly connected to the flute body adjacent a tone hole such that each flute key seals against a tone hole. As was the case above, each flute key includes a machined flute key cup having an integral, centered, externally threaded post; a machined flute stabilizing disc having an internally threaded hole, the stabilizing disc being selectively threadable around the post; a flute pad positioned within the key cup; a washer attached with the flute pad; and a pad screw passing through the washer and flute pad and affixed to the post.

In another aspect and as referenced above, the present disclosure also provides for a method for forming a flute key. The method includes machining a flute key cup to have an integral, centered, externally threaded post. A flute stabilizing disc is separately machined to have an internally threaded hole. The stabilizing disc is also machined to be selectively threadable around the post. A flute pad is thereafter positioned within the key cup. A washer is attached or otherwise positioned to connect to the flute pad. Finally, a pad screw is screwed through the washer, flute pad and stabilizing disc and into the post.

Finally, as can be appreciated by one in the art, the present invention also comprises a method for using the invention as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a cross-sectional, side-view illustration of a flute key with a solid machined cup of the prior art;

FIG. 2 is a cross-sectional, side-view illustration of a flute key with a stamped cup of the prior art;

FIG. 3A is an elevated-view illustration of a flute body, having flute keys in accordance with various embodiments of the present invention;

FIG. 3B is a side-view illustration of the flute body, having flute keys in accordance with various embodiments of the present invention;

FIG. 3C is a cross-sectional, side-view illustration of the flute body, having flute keys in accordance with various embodiments of the present invention;

FIG. 3D is a front-view illustration of the flute body, showing a flute key resting on a tone hole according to various embodiments of the present invention; and

FIG. 3E is a cross-sectional, front-view illustration of the flute body, showing a flute key resting on the tone hole according to various embodiments of the present invention.

FIG. 4A is an exploded-view illustration of a flute key according to various embodiments of the present invention;

FIG. 4B is an exploded-view illustration of a flute key with a solid machined cup of the prior art;

FIG. 4C is an exploded-view illustration of a flute key with a stamped cup of the prior art; and

FIG. 5 is a cross-sectional, side-view illustration of the flute key according to various embodiments of the present invention.

### DETAILED DESCRIPTION

The present invention relates to musical instruments and associated parts, and more particularly to a flute key having an improved flute key cup and associated stabilizing disc. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for”performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

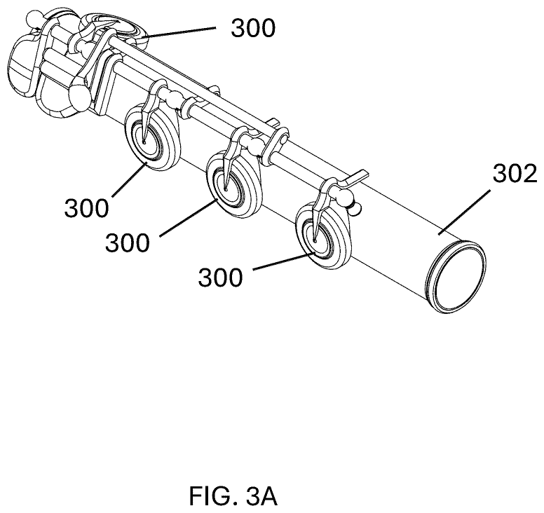

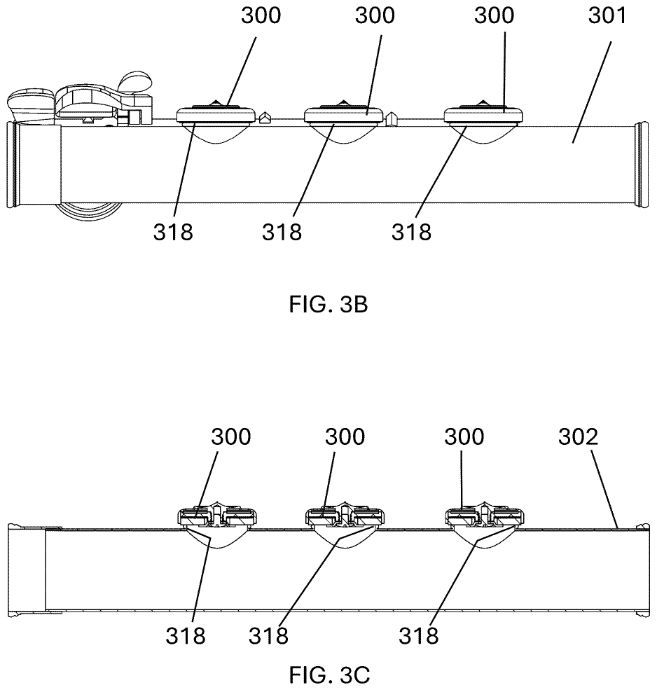

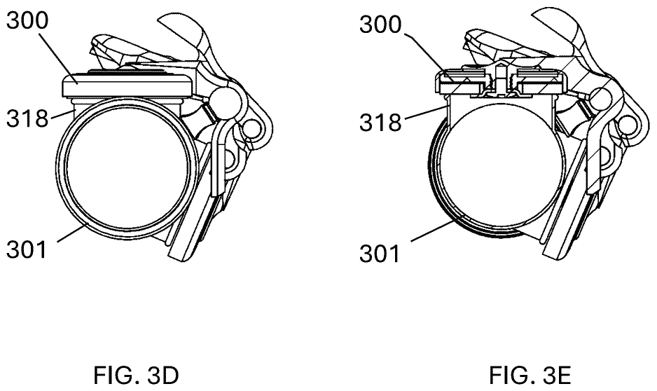

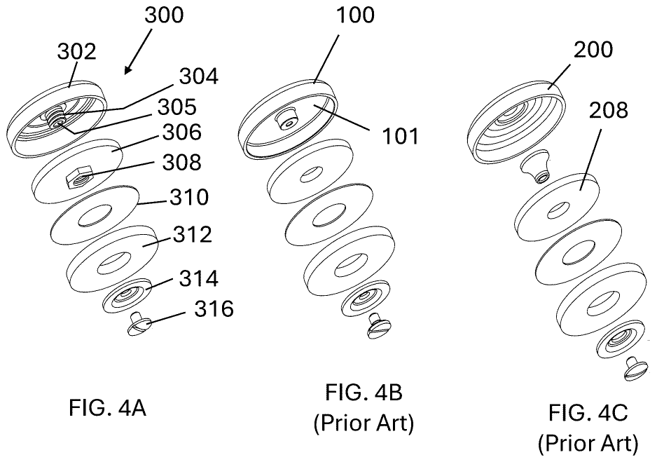

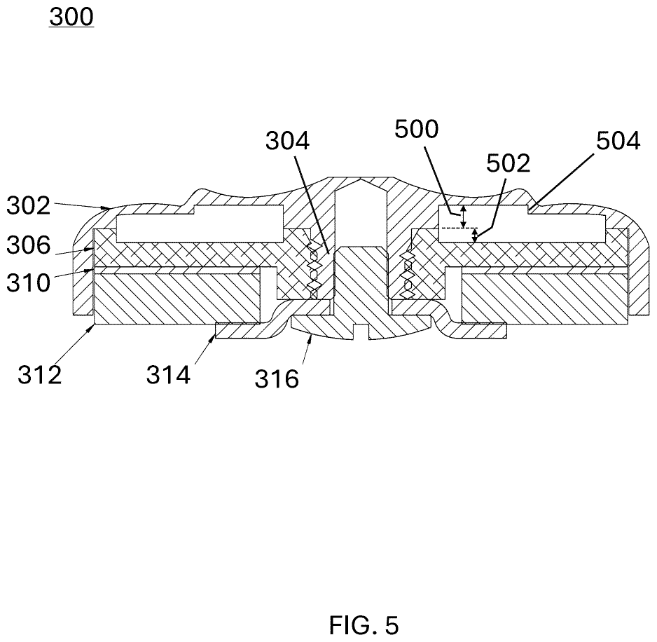

As shown in FIG. 3A, the present disclosure is directed to an improved flute key 300 as used with a flute and associated flute body 301. As shown in FIGS. 3B through 3E, the flute key 300 is formed to work with the flute body 301 and seal against a tone hole 318 of the flute. As described below, the flute key 300 of the present invention provides a marked improvement over the prior art through its construction and various components. For further understanding, FIGS. 4A and 5 provide exploded-view and cross-sectional illustrations of the flute key 300, respectively. To be contrasted with the prior art (shown in FIGS. 4B and 4C), the flute key 300 of the present invention (shown in FIGS. 4A and 5) includes a computer numerical control (CNC) machined flute cup 302 with an integral, centered, externally threaded post 304. The externally threaded post 304 also includes an internal bore 305 with threads to accommodate a pad screw 316. The cup 302 is CNC machined from any desired material, non-limiting examples of which include silver, gold, copper brass, etc.

Also included is a CNC machined flute pad stabilizing disc 306 with a corresponding internally threaded hole 308, allowing the stabilizing disc 306 to thread onto the CNC machined flute cup 302. The screw-in stabilizing disc 306, which bottoms out and locks into place inside the key cup 302, provides a more stable and consistent foundation for the installation of a shim 310 and flute pad 312 than the prior art. A washer 314 and the threaded pad screw 316 are then used to secure the pad 312 to the cup 302. The pad screw 316 can be selectively screwed into the interior threaded bore 305 hole formed within the post 304.

The threaded means of attachment of the present invention provides for a more versatile, stable, and repeatable way to secure the pad stabilizing disc 306 into the flute key cup 302 than existing methods. As noted above, existing flute keys include a solid machined key cup 100 with an integral flat interior 101 and glued stabilizing disc 108 (shown in FIG. 4B) or a glued-in floating stabilizing disc 208 used in stamped flute key cups 200 (shown in FIG. 4C), both methods of which include deficiencies. The type of CNC machined cup 302 with an externally threaded post 304 and associated screw-in stabilizing disc 306 (shown in FIG. 4A) according to the present disclosure has never been used on flute key cups before and provides for several functional improvements over the prior art as noted below.

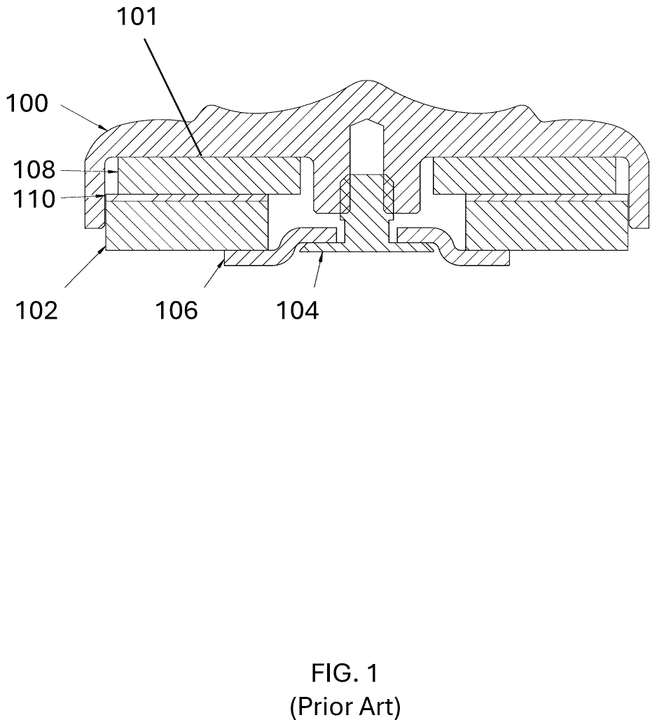

In addition to the improvements referenced above, the flute key 300 of the present disclosure (shown in FIG. 5) differs from the solid CNC machined key cup (show in FIG. 1) in that it allows for making the separate stabilizing disc 306 from varying materials and thicknesses. The ability to make the stabilizing disk 306 from varying materials and thicknesses creates an opportunity to control the weight of the entire assembly in varying degrees by the substitution of materials of different densities. The unique design also allows for a lighter machined key cup 302 than previously possible with solid machined key cups by virtue of the hollow spaces machined inside the cup (i.e., hollow cup space 500) and pad stabilizing disc (i.e., hollow disc space 502). In one aspect and as shown (although not limited thereto), the hollow cup space 500 can be stepped and formed in the cup 302 to circumferentially surround the post 304. The stepped aspect allows for decreasing weight while maintaining structural rigidity through the step face 504 that surrounds the post 304. Similarly, the hollow disc space 502 can be formed in the disc 306 such that when threaded onto the cup 302, the hollow disc space 502 circumferentially surrounds the post 304.

Unlike the solid cup of the prior art, the CNC machined cup 302 of the present disclosure also creates the opportunity to control the overall depth of the flute key cup 302 without remaking the entire flute mechanism by using stabilizing discs of varying thickness. This ability to control the overall depth (increasing or decreasing the interior depth) of the machined flute key cup 302 on a completed instrument provides the ability to control the amount and thickness of shims 310 used in the pad-cup assembly (i.e., the flute key 300). It also is superior to the solid machined key cup of the prior art in that the stabilizing disc 306 can be made from less expensive materials than the precious metals that are typically used in key cup manufacture, thereby reducing the precious metal content as compared to a solid silver machined cup with a flat interior. Further and in another aspect, because the interior stabilizing disc 306 can be made from a less expensive material and the present flute key cup 302 design has been made with as little mass as possible, the cup 302 can be CNC machined from solid gold. In this aspect, the amount of solid gold used in the machining of the flute key cup 302 itself is greatly reduced from prior art designs that have integral stabilizing discs, thereby making CNC machined solid gold flute key cups 302 economically possible.

Further and referring to FIG. 1, the solid machined flute key cup 100 of the prior art is exposed to various soldering and forming operations during the manufacture of the flute mechanism. These operations expose the solid machined key cup 100 to stresses relating to heat and forming. Referring to FIG. 5, the present invention keeps the critical internal surface of the pad stabilizing disc 306 separate from these stresses because it will be installed after the final manufacture of the mechanism is complete, rendering a more consistent pristine foundation for the pad 312.

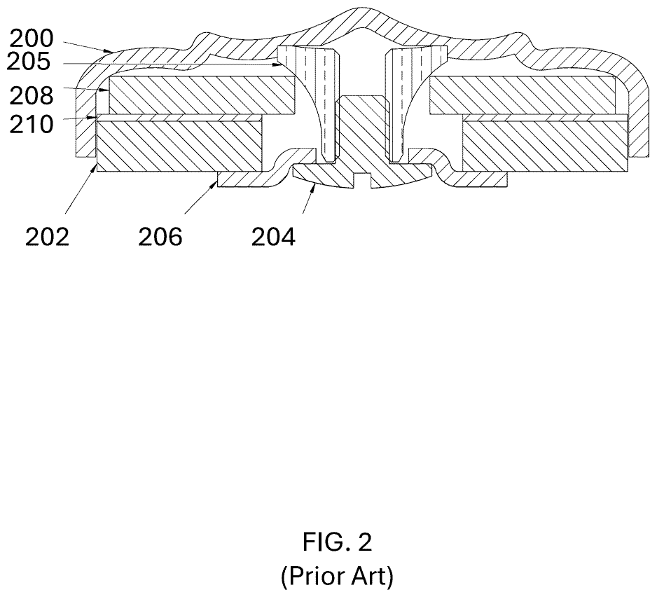

Additionally and referring again to FIG. 2, the present invention differs from the traditional stamped key cup 200 in that it is also produced at a much lower cost than the traditional stamped flute key cup 200. The screw-in locking stabilizing disc of the present invention (shown as element 306 in FIG. 5) also provides a superior more stable foundation than the glued-in floating stabilizing disc 208 as used in stamped cups 200. Further, because the key cup and the screw-in stabilizing disc of the present invention are entirely CNC machined, the entire assembly of the present invention is more dimensionally consistent and stable than the stamped cup 200 made with thin sheet stock with a glued-in floating stabilizing disc 208.

Thin, stamped cups 200 are prone to distortion when exposed to the heat and pressure stresses involved in the manufacture of the flute mechanism. Referring again to FIG. 5, the flute key 300 of the present disclosure differs from the traditional stamped cup design in that it is a CNC machined assembly with a separate CNC machined stabilizing disc 306. This allows for the disc 306 to be screwed-in and locked down into the CNC machined cup 302 when the mechanism is finished, not floated in and glued to a distorted thin stamped cup, ensuring a more dimensionally accurate and physically stable base for the installation of the flute pad 312. As alluded above, an issue with the gluing process of the prior art is that gluing a stabilizing disc into a pad cup results in varying overall interior cup depths because the volume of glue used is never exactly equal from cup-to-cup. This results in the glued in floating stabilizer riding higher in a cup with more glue, or riding lower with a cup with less glue. Compounding that, the even distribution of glue around the entire disc is never perfectly uniform, resulting in the stabilizing disc sitting slightly off level inside the cup. The present invention addresses this issue through a precisely CNC machined cup 300 and corresponding CNC machined stabilizing disc 306, proving a consistent and perfect base for the flute pad 312.

As can be appreciated by those skilled in the art, the screwed-in disc 306 can be interchangeable as desired and selectively locked into the key cup 302 when screwed against the machined inner surface of the CNC machined cup 302. This screwed in aspect provides for several functional improvements over the prior art. The screwed in disc 306 of the present invention provides a locked down interior foundation for the flute pad 312 installation. Further, by being interchangeable, a user can adjust the weight of the flute key by selectively using stabilizing discs 306 made from different thicknesses or materials of different densities, thus effecting the overall weight and balance of the completed flute. This control of the overall weight and how the weight is distributed on a completed flute mechanism aids in balancing the instrument for the player. Such adjustability is not possible with a conventional solid machined flute key cup design. Further, because the stabilizing disc 306 is removable, this allows for the manufacture of the flute mechanism to be completed without the interior flute stabilizing disc 306 in place; This is not possible with solid machined flute key cups.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A flute key, comprising:
a machined flute key cup having an integral, centered, externally threaded post;
a machined flute stabilizing disc having an internally threaded hole, the stabilizing disc being selectively threadable around the post;
a flute pad positioned within the key cup;
a washer attached with the flute pad; and
a pad screw passing through the washer, flute pad, and stabilizing disc and affixed to the post.

2. The flute key as set forth in claim 1, wherein each of the machined flute key cup and machined flute stabilizing disc are computer numerical control (CNC) machined.

3. The flute key as set forth in claim 2, wherein the post includes an internally threaded bore, with the pad screw affixed to the internally threaded bore.

4. The flute key as set forth in claim 3, further comprising a shim positioned between the stabilizing disc and flute pad.

5. The flute key as set forth in claim 4, wherein the key cup is machined to have a hollow cup space that circumferentially surrounds the post.

6. The flute key as set forth in claim 5, wherein the hollow cup space is stepped to include a step face that surrounds the post.

7. The flute key as set forth in claim 6, wherein the stabilizing disc is machined to have a hollow disc space that circumferentially surrounds the post.

8. A flute having an improved flute key, comprising:
a flute body having a plurality of tone holes;
a plurality of flute keys, each flute key being hingedly connected to the flute body adjacent a tone hole such that each flute key seals against a tone hole, wherein each flute key includes:
a machined flute key cup having an integral, centered, externally threaded post;
a machined flute stabilizing disc having an internally threaded hole, the stabilizing disc being selectively threadable around the post;
a flute pad positioned within the key cup;
a washer attached with the flute pad; and
a pad screw passing through the washer and flute pad and affixed to the post.

9. A method for forming a flute key, comprising acts of:
machining a flute key cup to have an integral, centered, externally threaded post;
machining a flute stabilizing disc having an internally threaded hole, the stabilizing disc being machined to be selectively threadable around the post;
positioning a flute pad within the key cup;
attaching a washer to the flute pad; and
screwing a pad screw through the washer, flute pad and stabilizing disc and into the post.
